(19) United States
(12) Patent Application Publication
(10) Pub. No.: US 2013/0128968 A1
(43) Pub. Date: May 23, 2013

(54) Method for predicting a shape of an encoded area using a depth map

(71) Applicant: POZNAN UNIVERSITY OF TECHNOLOGY, Poznan (PL)

(72) Inventors: Marek DOMANSKI, Poznan (PL); Jacek KONIECZNY, Poznan (PL); Maciej KURC, Poznan (PL); Robert RATAJCZAK, Lwowek (PL); Jakub SIAST, Skwierzyna (PL); Olgierd STANKIEWICZ, Poznan (PL); Jakub STANKOWSKI, Poznan (PL); Krzysztof WEGNER, Murowana Goslina (PL)

(73) Assignee: POZNAN UNIVERSITY OF TECHNOLOGY, Poznan (PL)

(21) Appl. No.: 13/680,740

(22) Filed: Nov. 19, 2012

(30) Foreign Application Priority Data
Nov. 17, 2011 (PL) P.397010

(51) Int. Cl. H04N 7/26

(52) U.S. Cl. CPC H04N 19/00569
USPC 375/240.12

(57) ABSTRACT

A method for predicting a shape of an encoded area using a depth map. The method includes synthesizing a virtual depth map and identifying disoccluded regions in the virtual depth map, wherein the disoccluded regions provide a predicted a shape of an area under compression.

### CROSS-REFERENCE TO RELATED APPLICATIONS

This application claims priority to Polish Patent Application No. P.397010, filed Nov. 17, 2011, the entire contents of which are hereby incorporated by reference.

### BACKGROUND

The invention relates to a method of predicting a shape of an encoded area using a depth map, applicable for compression and decompression of multiview sequences with depth maps.

The Multiview Video Coding (MVC) standard, which is the extension of the H.264/AVC (Advanced Video Coding) standard, is known in the literature. See, e.g., Y. Chen, Y.-K. Wang, K. Ugur, M. M. Hannuksela, J. Lainema, M. Gabbouj, “The Emerging MVC Standard for 3D Video Services”, EURASIP Journal on Advances in Signal Processing, Volume 2009; and “Joint draft 9.0 on multi-view video coding”, JVT-AB204, Hanover, Germany, 2008. A detailed description of the MVC standard can be found in “ISO/IEC 14496-10:2010. Information technology—Coding of audio-visual objects—Part 10: Advanced Video Coding”. The MVC standard defines a method of compression and coding of multiview video sequences, i.e., sequences that consist of more than one view. The compression and encoding of the consecutive views from the multiview video sequence are performed according to the coding order. All the already-encoded views are then used as a source of reference for encoding the currently coded view. The first view is coded according to the AVC/H.264 standard, without any reference view.

The basic case for compression of each view is encoding the whole image area. The only possibility to divide an image region into independently coded sub-regions is to split the coded view into multiple slices, and to use a Flexible Macroblock Ordering (FMO) tool which can change the order of the coded macroblocks. Nevertheless, this requires sending additional information in a bitstream, which has a negative impact on the compression efficiency.

The MPEG4 standard, which allows for encoding objects of arbitrary shape, is disclosed in the documentation of the ISO/IEC 14496 standard. The MPEG4 standard, however, requires that additional information, describing the shape of an object in form of a binary shape map or an alpha channel, be sent in a bitstream. Both methods have negative influence on the compression efficiency.

The methods known from the technical literature for coding the shape of the coded area do not use the method proposed in this invention.

The literature discloses multiview scene representation in a form of the multiview video sequences. Such models can have various representations: stereoscopic depth maps (see, e.g., Y.-S. Ho, “High-resolution Depth Map Generation for Free-viewpoint 3DTV Services”, IEEE International Conference on Multimedia & Expo 2010 (ICME 2010), July 2010), grids (see, e.g., A. Rovid, A. R. Varkonyi-Koczy, P. Varlaki, “3D model estimation from multiple images,” Proceedings of IEEE International Conference on Fuzzy Systems, 2004, chapter 3, pp. 1661-1666, 2004), or other forms (see, e.g., A. A. Alatan, Y. Yemez et al., “Scene Representation Technologies for 3DTV—A Survey”, IEEE Transactions on Circuits, Systems and Video Technology, pp. 1587-1605, 2007). Regardless of particular form, a spatial model of the scene allows (directly or indirectly—see, e.g., Y. Mori, N. Fukushima, T. Yendo, T. Fujii, M. Tanimoto's “View generation with 3D warping using depth information for FTV”. Signal Processing: Image Communication. vol. 24, edition 1-265-72, 2009) to define the stereoscopic depth for every point of the particular view. The stereoscopic depth can be represented both as a map of distances to a given point of the scene, and as normalized disparity values, as defined in ISO/IEC JTC1/SC29/WG11, “Report on Experimental Framework for 3D Video Coding”, N11631, Guangzhou, China, 2010. Research is also being conducted on the efficient compression of images and depth map compression. See, e.g., B.-B. Chai, S. Sethuraman, H. S. Sawhney, “A depth map representation for real-time transmission and view-based rendering of a dynamic 3D scene,” 3D Data Processing Visualization and Transmission, 2002. Proceedings. First International Symposium on, pp. 107-114, 2002.

The literature discloses the Depth Image Based Rendering technique, as described in C. Felm's “Depth-Image-Based Rendering (DIBR), compression and transmission for a new approach on 3D-TV,” Proc. SPIE Stereoscopic Displays and Virtual Reality Systems XI, pp. 93-104, San Jose, Calif., USA, 2004. DIBR allows the synthesis of a new virtual view based on stereoscopic depth corresponding to some number of input views at viewpoint different from the viewpoint of the input views, as described in D. Tian, P. L. Lai, P. Lopez, C. Gomila, “View synthesis techniques for 3D video”, Proc. SPIE 2009, San Diego, 2009.

Disoccluded region detection, based on synthesis of virtual view with the use of the DIBR technique, is also known in the literature. See, e.g., E-K. Lee, Y-S Kang, Y.-K. Jung; Y.-S. Ho, “Three-dimensional video generation using foreground separation and disocclusion detection”, 3DTV-Conference: The True Vision—Capture, Transmission and Display of 3D Video (3DTV-CON), 2010.

Efficient coding of the shape of the encoded regions in multiview compression, i.e., the ones where the coded representation of the shape is not made redundant, is still an unsolved technical problem. The techniques known in the literature do not use the methods of the present invention.

### SUMMARY

The essence of the invention is a method of predicting a shape of an encoded area using a depth map, in which a virtual depth map Vₙ is synthesized. Subsequently, in the synthesized virtual depth map, disoccluded regions are identified and provide a prediction of the shape of the area under compression Sₙ.

By the application of the method according to the invention, the following technical and economic effects can be achieved: a reduction of redundancy in information describing the shape of areas in a multiview compression encoded using a depth map; a possibility to increase the efficiency of compression of images and multiview sequences with a depth map by efficiently omitting, when encoding, portions of the image that are available to the encoder and decoder from other views; and an increase of the compression ratio of multiview sequences and video sequences with a depth map.

### BRIEF DESCRIPTION OF THE FIGURES

FIG. 1 shows an exemplary embodiment of the invention, in the form of a scheme of compression and decompression of multiview video sequences performed with a method of predicting the shape of an encoded area using a depth map.

### DETAILED DESCRIPTION

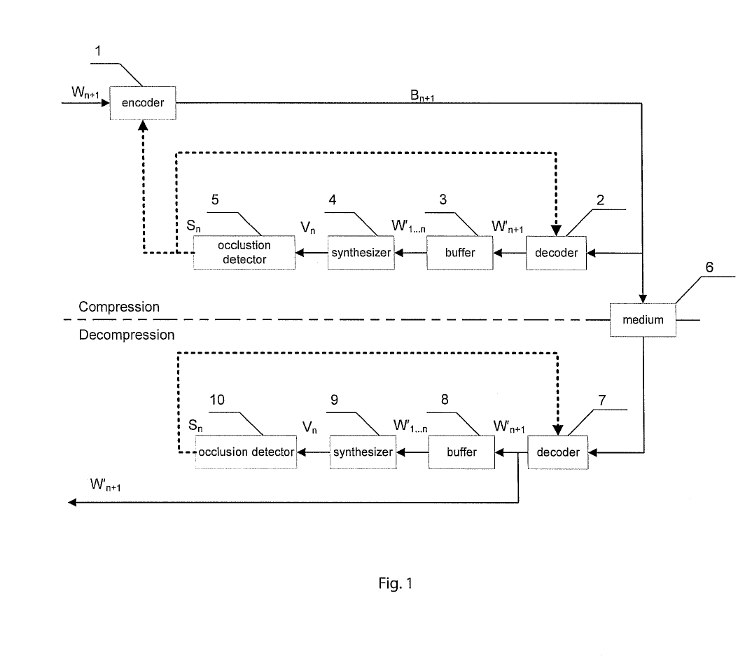

The invention can be illustrated by the following exemplary embodiment and with reference to FIG. 1.

An input multiview video sequence having a K amount of video sequences and corresponding depth maps can be subjected to encoding (compression), transmission (via a medium) and decoding (decompressing). The views can be processed in the W₁, W₂, . . . , W_{K} order.

Each sequentially processed view Wₙ₊₁ can be compressed in an encoder 1 controlled with a predicted shape of the encoded region Sₙ, estimated based on previously compressed views. If the first view W₁ is being compressed, the predicted shape of the encoded region Sₙ may be equal to the entire image area. The encoder 1 can use the predicted shape of the encoded region Sₙ directly, without including any additional information in the compressed output bitstream. The compression result may be a compressed binary stream Bₙ₊₁, which can be fed into two parallel paths: a loopback path back to encoder 1, and a transmission path through a transmission medium 6 to a decoder path. Subsequently, the binary stream Bₙ₊₁ can undergo uniform processing on both paths.

On the loopback path to encoder 1, the compressed binary stream Bₙ₊₁ can be decoded by a decoder 2, which can be controlled with a predicted shape of the encoded region Sₙ so as to produce a video sequence reconstruction W′ₙ₊₁ of the input sequence Wₙ₊₁. The sequence can be stored in a buffer 3. At the same time, the sequences already stored in buffer 3—i.e., W′₁, . . . , W′ₙ,—may be sent to a synthesizer 4 for the synthesis of a depth map Vₙ at a spatial position corresponding to the coded view Wₙ₊₁. In the resultant depth map Vₙ, disoccluded regions that are occluded in views W′₁, . . . , W′ₙ may be detected by an occlusion detector 5. These regions can be used as the predicted shape of the encoded region Sₙ which can control the encoding of view Wₙ₊₁ by encoder 1, and the decoding thereof by decoder 2.

On the decoder path, the compressed binary stream Bₙ₊₁ can be processed in the same way as in the loopback path, but with the use of: decoder 7, buffer 8, synthesizer 9, and occlusion detector 10, which can be equivalent to those on the compression side.

The foregoing exemplary detailed description of the realization of the respective steps of the technique of processing synthesized images with adaptive blurring of the synthesized images based on stereoscopic depth information, according to the invention, should not be interpreted as limiting the idea of the invention to the described example. One skilled in the art of image synthesis techniques can recognize that the described example of the technique can be modified, adjusted or performed by means of equivalent realizations, without departing from its technical character, and without diminishing the technical effects to be achieved.

What is claimed is:

1. A method for predicting a shape of an encoded area using a depth map, comprising:
synthesizing a virtual depth map; and
identifying disoccluded regions in the virtual depth map;
wherein the disoccluded regions provide a predicted a shape of an area under compression.

2. The method of claim 1, wherein the virtual depth map is synthesized based on at least one previously compressed view.

3. The method of claim 1, further comprising compressing a view using the predicted shape of the area under compression.

4. The method of claim 3, further comprising feeding the compressed view into a loopback path and a transmission path.

5. A method for predicting a shape of an encoded area using a depth map, comprising:
a) obtaining a view of a multiview video sequence;
b) obtaining a predicted shape of at least one encoded region;
c) encoding the view of the multiview video sequence, using the predicted shape of the at least one encoded region, to obtain an encoded view;
d) synthesizing a virtual depth map at a spatial position corresponding to the encoded view; and
e) identifying disoccluded regions in the virtual depth map to obtain a subsequent predicted shape of an encoded region.

6. The method of claim 5, further comprising:
iteratively repeating steps a-e for a subsequent view in the multiview video sequence;
wherein the subsequent predicted shape of step e is used as the predicted shape of step b.
